(19) United States
(12) Patent Application Publication
(10) Pub. No.: US 2015/0372392 A1
(43) Pub. Date: Dec. 24, 2015

(54) OVERLAPPING MULTI-BOARD INTEGRATED ANTENNA DEVICE

(71) Applicants: Cheng-Chang LEE, Taoyuan County (TW); Shih-Keng HUANG, Tainan County (TW); Wen-Sheng CHUNG, Hsinchu City (TW)

(72) Inventors: Cheng-Chang LEE, Taoyuan County (TW); Shih-Keng HUANG, Tainan County (TW); Wen-Sheng CHUNG, Hsinchu City (TW)

(73) Assignee: WHA YU INDUSTRIAL CO., LTD., Hsinchu City (TW)

(21) Appl. No.: 14/479,960

(22) Filed: Sep. 8, 2014

(30) Foreign Application Priority Data
Jun. 19, 2014 (TW) 103210785

(51) Int. Cl. H01Q 21/00; H01Q 1/42; H01Q 1/24; H01Q 9/04; H01Q 1/48

(52) U.S. Cl. CPC H01Q 21/0006; H01Q 9/0407; H01Q 1/48; H01Q 1/24; H01Q 1/42

(57) ABSTRACT

An overlapping multi-board integrated antenna device includes a load plate with grounding portion and at least two-circuit board antenna units set in the grounding portion. Each circuit board antenna unit includes a circuit board kit, at least one antenna set on the surface of the circuit board kit and a feed line electrically connected with the antenna. Each circuit board kit includes a vertical plate and an interconnected horizontal plate. The antenna for the circuit board is set on the vertical plate. Two horizontal plates abutted in different circuit board antenna units are formed into an integrated structure via the same plate, and a joint portion is formed between two horizontal plates. Thus, the integrated configuration of multiple circuit board antenna units can be minimized to reduce the component amount and cost, so as to meet multi-function demands of antenna with better applicability and industrial and economic benefits.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an antenna device, and more particularly to an innovative one which is designed with an overlapping multi-board integrated structure.

2. Description of Related Art Including Information Disclosed Under 37 CFR 1.97 and 37 CFR 1.98

The antenna device discussed in the present invention relates generally to a circuit board antenna. The circuit board antenna is utilized in such a manner that a plurality of circuit board antennas are incorporated into one structure to meet the functional requirements of multi-frequency communication products, such as an all-in-one antenna.

Yet, such conventional structures often allow multi-circuit board antennas to be distributed at interval. With such a structure, when more circuit board antennas are to be arranged, the equipment's setting area will be increased, leading to oversizing of the antenna device without space-saving benefit.

Further, some supporting structures (such as props, frame plates, etc.) are required to stabilize the protruding end structure in some circuit board antenna devices with three-dimensional protruding or bending structure, increasing the component cost sharply.

Thus, to overcome the aforementioned problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the unique structure and technical characteristics of the present invention wherein an overlapping multi-board integrated antenna device mainly comprises a circuit board kit for each circuit board antenna unit, comprising of a vertical plate and an interconnected horizontal plate. The antenna for the circuit board is set at least on the vertical plate. Two horizontal plates abutted in different circuit board antenna units are formed into an integrated structure via the same plate, and a joint portion is formed between two horizontal plates. As compared with prior art, the present invention allows the setting scope of the antenna spreads from vertical plate to horizontal plate, such that the scope of antenna is shifted from vertical to horizontal surface, thus the antenna's setting height can be reduced. The joint portion is set in a way that the circuit boards abutting two circuit board antenna units can be supported and positioned, thus the available amount of locators can be dramatically reduced. Moreover, said joint portion is located in the upper layer, an excellent installation position can be provided for a satellite positioning signal receiver. Based on the above analysis, the present invention allows space-saving configuration of the multiple circuit board antenna units, thus reducing the amount of components and the cost to meet multi-functional demands of antenna with better applicability and industrial and economic benefits.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a partially exploded perspective view of the preferred embodiment of the present invention.

FIG. 2 is an assembled perspective view of the preferred embodiment of the present invention (note: housing component removal).

FIG. 3 is a vertical sectional view of the preferred embodiment of the present invention.

FIG. 4 is an application view of the present invention wherein the antenna's setting scope spreads from vertical plate to horizontal plate.

FIG. 5 is an application view of the present invention wherein the grounding portion and load plate are jointly set on the same plate.

### DETAILED DESCRIPTION OF THE INVENTION

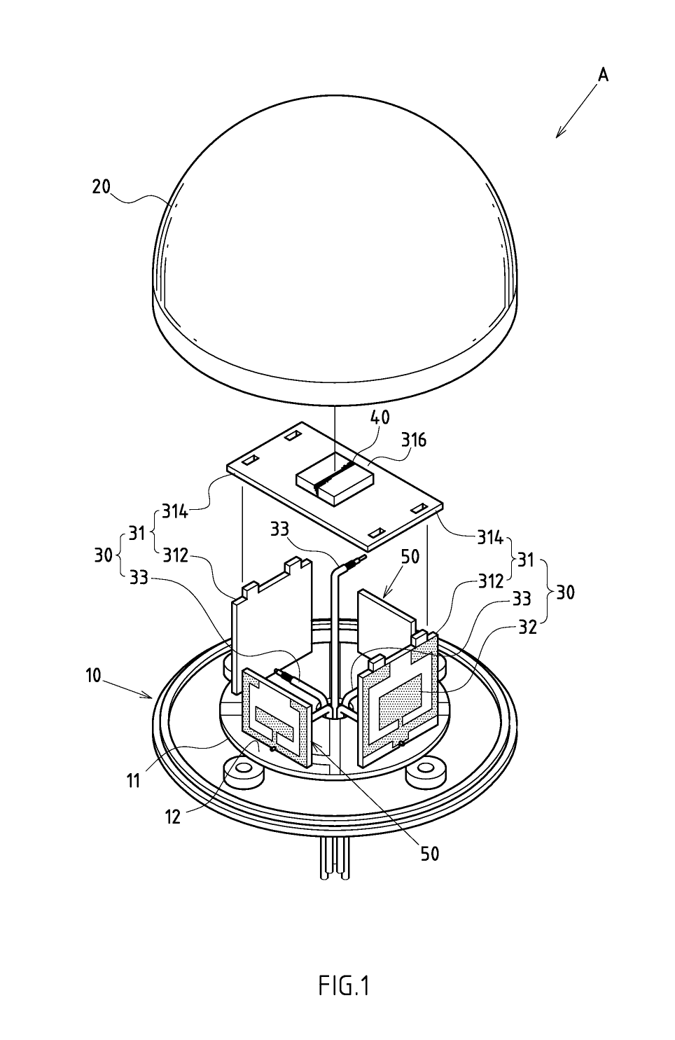

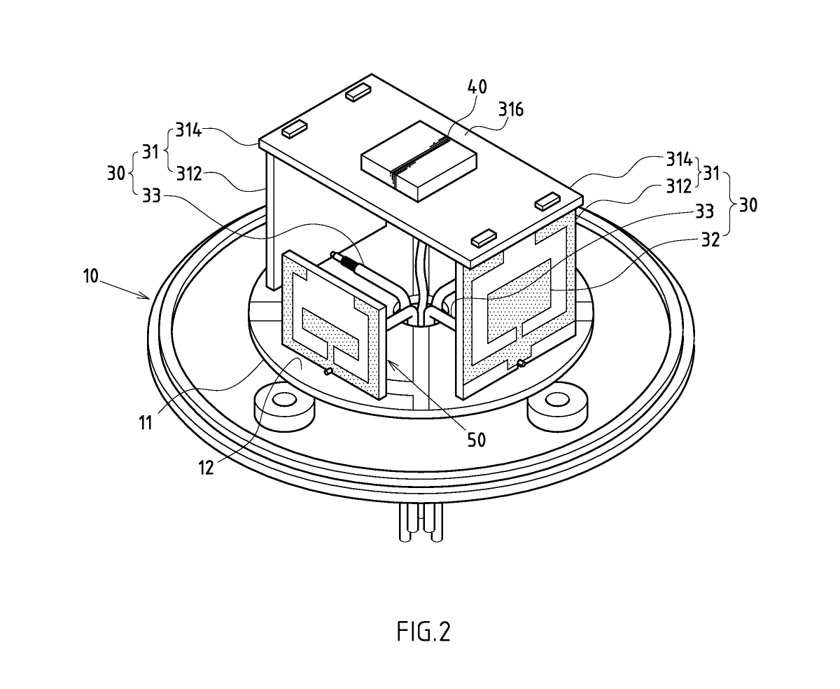

FIGS. 1-3 depict preferred embodiments of an overlapping multi-board integrated antenna device, which, however, are provided for only explanatory objective for patent claims. Said overlapping multi-board integrated antenna device A comprises a load plate 10 with grounding portion 11, and at least two circuit board antenna units 30 (note: indicated by same component symbol) set on the grounding portion 11. Each circuit board antenna unit 30 includes a circuit board kit 31, at least one antenna 32 set on the surface of circuit board kit 31 and a feed line 33 electrically connected with the antenna 32. The invention is characterized in that each circuit board kit 31 of the circuit board antenna unit 30 includes a vertical plate 312 and an interconnected horizontal plate 314. The antenna 32 for the circuit board kit 31 is set at least on the vertical plate 312. Two horizontal plates 314 abutted in different circuit board antenna units 30 are formed into an integrated structure via the same plate, and a joint portion 316 is formed between two horizontal plates 314.

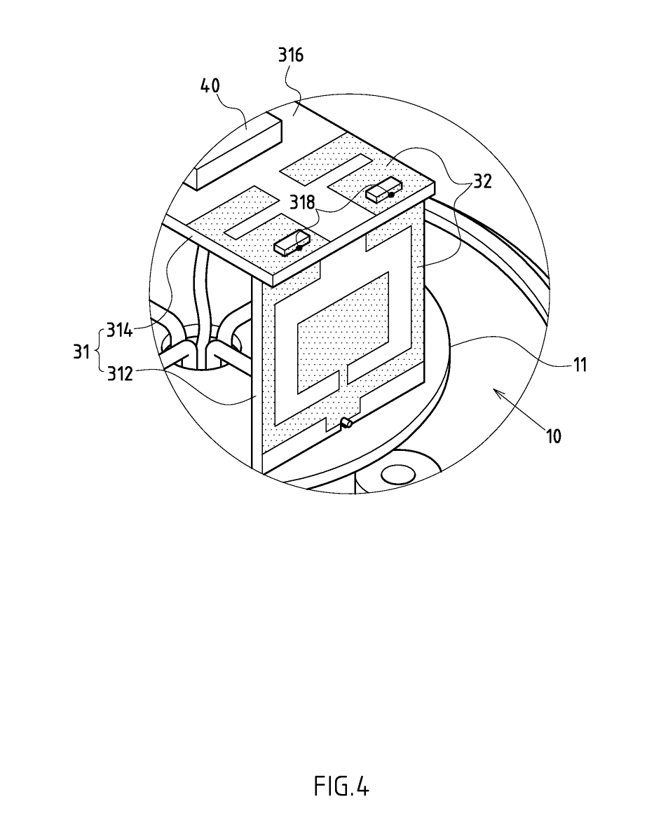

Referring to FIG. 4, the setting scope of antenna 32 for the circuit board kit 31 can spread from vertical plate 312 to horizontal plate 314. Of which, the antennas 32 for both the vertical plate 312 and horizontal plate 314 can be electrically connected by flange and perforation, and then securely firmly by the soldering point 318 formed by solder.

Referring to FIGS. 1-3, a satellite positioning signal receiver 40 can be set onto said joint portion 316.

Referring to FIGS. 1-3, the grounding portion 11 of the load plate 10 is larger in relation to the horizontal plate 314 of the circuit board kit 31 for the circuit board antenna unit 30 as well as its joint portion 316, thus an extended area 12 not covered by the horizontal plate 314 and joint portion 316 is formed. Moreover, the second circuit board antenna unit 50 is additionally set on the extended area 12. In the preferred embodiment, the setting amount of said second circuit board antenna unit 50 is not limited. As shown in FIG. 1, two groups of second circuit board antenna units 50 are set on the extended area 12.

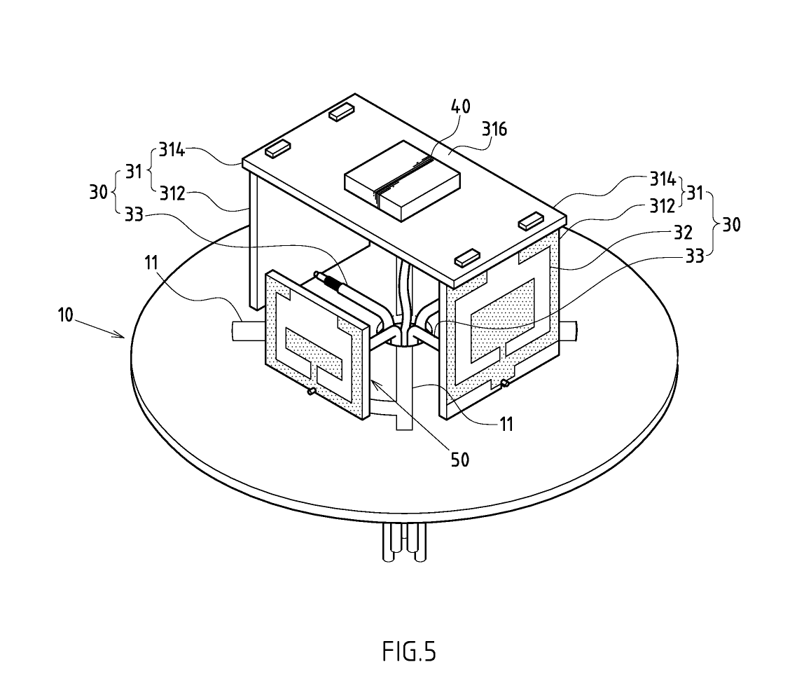

Of which, the grounding portion 11 of the load plate 10 is made of a circuit board (as shown in FIG. 1) or a conductor plate. If it is made of a circuit board , the grounding portion 11 can be set into local area distribution. Said grounding portion 11 and load plate 10 can be separately set onto different plates (as shown in FIG. 1) or set into the same plate (as shown in FIG. 5, a grounding portion 11 is formed by a local conductor layer arranged on a circuit board).

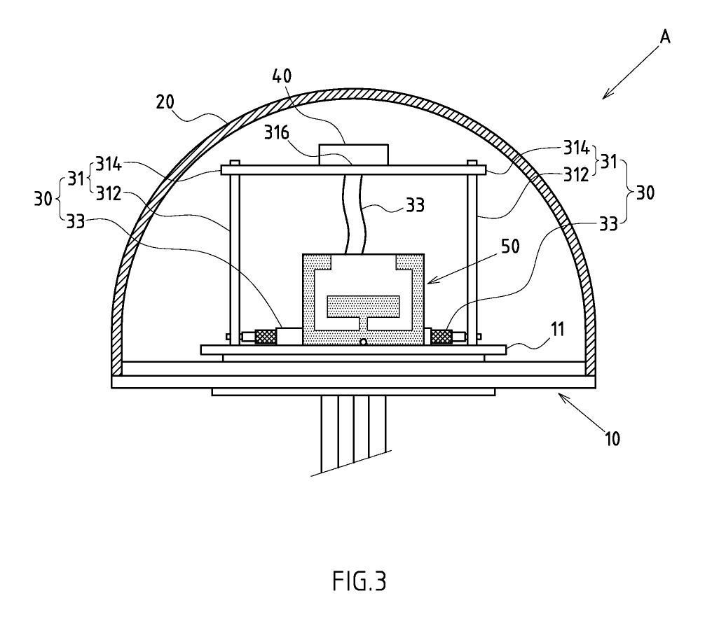

Referring to FIGS. 1 and 3, a housing 20 can be set on the load plate 10, such that the circuit board antenna unit 30 is covered into the housing 20.

We claim:

1. An overlapping multi-board integrated antenna device comprising a load plate with grounding portion, and at least two circuit board antenna units set on the grounding portion; each circuit board antenna unit includes a circuit board kit, at least one antenna set on the surface of circuit board kit and a feed line electrically connected with the antenna; it is characterized by that:
each circuit board kit of circuit board antenna unit includes a vertical plate and an interconnected horizontal plate interconnected; the antenna for the circuit board kit is set at least on the vertical plate;
two horizontal plates abutted in different circuit board antenna units are formed into an integrated structure via the same plate, and a joint portion is formed between two horizontal plates.

2. The device defined in claim 1, wherein the setting scope of antenna for the circuit board kit can spread from vertical plate to horizontal plate.

3. The device defined in claim 2, wherein the antennas for both the vertical plate and horizontal plate can be electrically connected by flange and perforation, and then securely firmly by the soldering point formed by solder.

4. The device defined in claim 3, wherein a satellite positioning signal receiver is set on said joint portion.

5. The device defined in claim 4, wherein the grounding portion of the load plate is larger in relation to the horizontal plate of the circuit board kit for the circuit board antenna unit as well as its joint portion, thus an extended area not covered by the horizontal plate and joint portion is formed; the second circuit board antenna unit is additionally set on the extended area;

6. The device defined in claim 4, wherein the grounding portion of the load plate is made of a circuit board or a conductor plate; said grounding portion and load plate can be separately set on different plates or jointly set on the same plate.

7. The device defined in claim 5, wherein a housing is set in the load plate to make the circuit board antenna unit covered by the housing.

8. The device defined in claim 6, wherein a housing is set in the load plate to make the circuit board antenna unit covered by the housing.
